(19) United States
(12) Patent Application Publication
(10) Pub. No.: US 2017/0275449 A1
(43) Pub. Date: Sep. 28, 2017

(54) AQUEOUS COATING COMPOSITIONS

(71) Applicant: BASF SE, Ludwigshafen (DE)

(72) Inventors: Audrey FUJII-COSYNS, Mannheim (DE); Arno TUCHBREITER, Southfield, MI (US); Frank FISCHER, Kirchheim (DE); Son NGUYEN-KIM, Hemsbach (DE)

(73) Assignee: BASF SE, Ludwigshafen (DE)

(21) Appl. No.: 15/506,577

(22) PCT Filed: Aug. 25, 2015
(86) PCT No.: PCT/EP2015/069391

§ 371 Date: Feb. 24, 2017

(30) Foreign Application Priority Data
Aug. 26, 2014 (EP) 14182263.5

(51) Int. Cl. C08L 39/06; C08F 6/00; C08F 283/06; C08F 226/10; C08F 220/56

(52) U.S. Cl. CPC C08L 39/06; C08F 226/10; C08F 220/56; C08F 283/06; C08F 6/003

(57) ABSTRACT

The invention relates to an aqueous pigmented coating composition containing at least one polymer P1 in the form of an aqueous polymer dispersion, and at least one water-soluble polymer P2 that is composed of ethylenically unsaturated monomers M and contains at least 30% by weight of polymerized N-vinylpyrrolidone in relation to the total amount of monomers M. The invention further relates to the use of the aqueous pigmented coating compositions of the invention for coating tannin-containing substrates, a coating method, and the coated substrates.

The present invention relates to aqueous coating compositions based on aqueous polymer dispersions which are suitable in particular for the coating of tannin-containing substrates such as wood and which lead in particular to a reduction in color changes in the coating that are caused by tannin.

Tannins are water-soluble, phenolic or polyphenolic compounds which occur naturally in woods and give them the characteristic inherent yellow to brown color. Tannins, dissolved by water, may migrate to the wood surface and lead to unattractive discoloration even in coated woods. Particularly after heavy rainfall, therefore, in light-colored wood coatings, brown runs and yellow knot marks suddenly appear, and detract esthetically from the appearance of the coated woods. The phenomenon of color strikethrough may occur not only under wet conditions, such as rainfall, but also even during the application of water-based coating formulations.

It is known fundamentally that by addition of certain additives to conventional coating compositions, it is possible to achieve a tannin blocking effect—in other words, the resulting coatings exhibit significant reduction in the color runs and color strikethrough caused by tannin. The mode of action of these additives is based essentially on their fixing of the water-soluble wood constituents. For instance, there are various proposals of coating compositions containing zinc oxide. However, experience shows that long drying times of generally between 24 hours and 36 hours must be maintained between the individual coating operations, so as to rule out the possibility of redissolution and mobilizing of the wood constituents. In spite of this, these systems are not one hundred percent reliable, particularly in the case of pigment-containing coating formulations. In particular, the development of color strikethrough cannot be generally prevented using these coating compositions.

DE-A 19908719 describes coating compositions for woods that are based on aqueous acrylate dispersions and which, for the purpose of preventing color runs and color strikethrough, comprise a water-soluble, amine-containing polymer, more particularly polyethyleneimine. It is assumed that the amine-containing polymers fix the water-soluble wood constituents within the wood pores and so reduce bleeding and resultant discoloration. But the coatings obtained prove to have only limited weathering resistance, since they tend toward yellowing on exposure to light, especially sunlight.

DE 10 2011 079 112 describes aqueous coating compositions which, as well as a disperse binder polymer, comprise highly branched melamine polymers or melamine-urea polymers as an additive for reducing tannin-related discoloration. These polymers are comparatively costly and inconvenient to prepare, and therefore expensive, and are not available commercially on an industrial scale.

It is an object of the present invention, therefore, to provide additives for aqueous coating material compositions which give aqueous coating compositions an improved tannin blocking effect. Moreover, they ought to have little or none of the disadvantages of the prior art - that is, they ought to be easy to process and ought also not, or not significantly, to detract from the stability of the coating compositions and the mechanical stability of the coatings. The additives ought in particular to be active in the case of pigment-containing coatings as well, since the pigments facilitate the penetration of water into the coatings and therefore fundamentally promote bleeding of the wood constituents.

It has been found, surprisingly, that water-soluble or water-dispersible polymers which are composed of ethylenically unsaturated monomers and which comprise in copolymerized form at least 30 wt %, based on the total amount of the monomers M constituting the polymer P2, of N-vinylpyrrolidone impart a good tannin blocking effect to aqueous, pigment-containing coating compositions and therefore greatly reduce unwanted discoloration on coated, tannin-containing substrates such as wood. Moreover, these polymers are available commercially on an industrial scale and do not, or do not significantly, detract from the stability of the coating compositions, from their ease of processing, or from the mechanical stability of the coatings obtained from them.

The invention therefore relates to aqueous, pigment-containing coating compositions which comprise the following constituents:
a) at least one polymer P1 in the form of an aqueous polymer dispersion and
b) at least one water-soluble polymer P2 which is composed of ethylenically unsaturated monomers M and which comprises in copolymerized form at least 30 wt %, more particularly at least 35 wt %, and more particularly at least 40 wt %, based on the total amount of monomers M, of N-vinylpyrrolidone.

Likewise subject-matter of the present invention is the use of the aqueous coating formulation for coating substrates containing tannin, a method for coating substrates, and the substrates coated by this method.

A further subject of the present invention is the use of water-soluble polymers (polymers P2) which are composed of ethylenically unsaturated monomers M and which comprise in copolymerized form at least 30 wt %, based on the monomers M, of N-vinylpyrrolidone for improving the tannin blocking effect of aqueous coating compositions.

The water-soluble polymers P2 used in accordance with the invention endow aqueous, pigment-containing coating compositions with a good tannin blocking effect, particularly during coating itself (early tannin blocking effect). There is likewise a good tannin blocking effect of the coating on exposure to moisture (late tannin blocking effect). In this way, therefore, the polymers P2 reduce or prevent unwanted discoloration on coated, tannin-containing substrates such as wood, particularly during the coating operation itself, but also in the coated state. A tendency toward yellowing on the part of the coatings under light exposure is not observed, or is observed only to a very small extent. Moreover, the polymers P2 are available commercially on an industrial scale and do not, or do not significantly, detract from the stability of the coating compositions, from their ease of processing, or from the mechanical stability of the coatings obtained from them.

The tannin blocking effect can be determined easily from the discoloration on the coating on a tannin-containing substrate in comparison to a coating on glass. The discoloration can be determined in a conventional way by photometry.

The water-soluble polymers P2 that are used in accordance with the invention and are present in the coating compositions of the invention are known from the prior art, as for example from DE 922378, DE 963057, EP 104042, DE 19950229, EP 418721, WO 01/29100, WO 2003/092640 and WO 2005/123014, to which reference is hereby made. The polymers P2, moreover, are available commercially, as additives for cosmetics, for pharmacy, as dispersants, and as thickeners, for example, under commercial designations such as Luviquat®, as for example Luviquat® FC, Luviquat® HM, Luviquat® MS, Luviquat® Care, Luviquat® UltraCare, Luviquat® Hold or Luviquat® Supreme, Luviskol®, as for example Luviskol® VA, Luvitec®, as for example Luvitec® VA64W or Luvitec®K30, Luviset®, as for example Luviset® clear, Kollidon®, as for example Kollidon® K17, K25, K30 or K90, or VA64, and various Collacral® grades, as for example Collacral® VAL from BASF SE.

The polymers P2 are typically soluble in water, meaning that their solubility in deionized water at 20° C. is generally at least 5 g/l.

The polymers P2 generally have a number-average molecular weight Mₙ in the range from 5000 to 200 000 g/mol, more particularly in the range from 7000 to 150 000 g/mol, and especially in the range from 10 000 to 100 000 g/mol. The weight-average molecular weight M_{w} is generally 5500 to 500 000 g/mol, more particularly 10 000 to 400 000 g/mol, and especially 15 000 to 250 000 g/mol. The polydispersity (PD; i.e., ratio of M_{w} to Mₙ) is preferably at least 1.1, more preferably at least 1.5.

In general the polymers P2 are not crosslinked, and they preferably have a substantially linear structure with an average of less than 10% of branching locations, based on the copolymerized monomer units.

The figures given in the context of the present invention for molecular weights (Mₙ, M_{w}) and for the polydispersity relate to values arising from gel permeation chromatography (GPC) in hexafluoroisopropanol or tetrahydrofuran as solvent, with PMMA calibration.

Another measure which can be used for the molecular weight is the K value, which is typically in the range from 10 to 100, more particularly in the range from 15 to 80, and especially in the range from 20 to 60. The K value according to Fikentscher can be determined by means of capillary viscosimetry on dilute aqueous solutions, as for example 1 wt % strength solutions of the polymer P2, and is customarily reported for commercially available polymers P2. The K value may be determined in analogy to that of Fikentscher, Cellulosechemie, vol. 13 (1932), pp. 58-64 or according to that in DIN EN ISO 1628-1:2012.

Generally speaking, the polymers P2 are neutral or cationic, and in particular they have no acid groups. In preferred embodiments, the polymers P2 are neutral.

The polymers P2 may be homopolymers of N-vinylpyrrolidone, more particularly polyvinylpyrrolidone having a K value in the range from 15 to 70, especially in the range from 20 to 50.

In preferred embodiments, the polymers P2 are copolymers which as well as N-vinylpyrrolidone also comprise in copolymerized form one or more neutral or cationic, monoethylenically unsaturated monomers. The fraction of N-vinylpyrrolidone, based on the total amount of the monomers M, is then preferably in the range from 30 to 90 wt %, more particularly 35 to 85 wt %, and especially 40 to 80 wt %.

Especially preferred polymers P2 are copolymers which consist of or comprise in copolymerized form the following monomers:
a) 30 to 90 wt %, more particularly 35 to 85 wt %, and especially 40 to 80 wt %, of N-vinylpyrrolidone as monomer A,
b) 10 to 70 wt %, more particularly 15 to 65 wt %, and especially 20 to 60 wt % of at least one neutral, monoethylenically unsaturated monomer as monomer B and optionally
c) 0 to 20 wt %, more particularly 0 to 15 wt %, of optionally a cationic monomer as monomer C, e.g., 0.1 to 20 wt % or 0.5 to 15 wt %;

the figures in wt % being based on the total mass of the monomers M, and the monomers A and B accounting for at least 80 wt %, more particularly 85 wt %, based on the total mass of the monomers M. The total amount of the monomers A), B), and C) amounts in particular to at least 99 wt %, based on the total amount of the monomers M.

Examples of suitable monomers B are
b1) vinyl esters of saturated C2-C12 monocarboxylic acids, such as vinyl acetate, vinyl propionate, vinyl hexanoate, and vinyl octanoate, and also vinyl esters of branched aliphatic monocarboxylic acids having 6 to 12C atoms, these being vinyl esters of what are called Versatic® acids, which are sold as VeoVa®X monomers (X stands for the number of carbon atoms) by Monomentive;
b2) primary amides of monoethylenically unsaturated C₃-C₆ monocarboxylic acids, more particularly acrylamide or methacrylamide;
b3) N-vinyl lactams having 7 to 10C atoms, e.g., N-vinylpiperidin-2-one or N-vinylcapro-lactam;
b4) vinyl-substituted nitrogen heteroaromatics, such as 2-, 3- or 4-vinylpyridine, 1-vinyl-imidazole, 2-methyl-1-vinylimidazole, and 4-methyl-1-vinylimidazole;
b5) N—C₁-C₄ alkyl amides and N,N-di-C₁-C₄ alkyl amides of monoethylenically unsaturated C₃-C₆ monocarboxylic acids, such as N-methylacrylamide, N-ethylacrylamide, N,N-dimethylacrylamide, N-methylacrylamide, N-ethylacrylamide, N,N-dimethylacrylamide, and tert-butylacrylamide;
b6) N-vinyl amides of saturated C₁-C₆ monocarboxylic acids, such as N-vinylformamide, N-vinylacetamide, or N-vinylpropionamide;
b7) C₁-C₃ alkyl acrylates, such as methyl acrylate, ethyl acrylate, n-propyl acrylate, and also methyl methacrylate;
and mixtures thereof.

Preferred monomers B are selected from groups b1), b2), b3), and b6).

Preferred neutral monomers B are, in particular, those which have a water-solubility of at least 10 g/l, more particularly at least 20 g/l, at 20° C. These include in particular:
b1′) vinyl esters of saturated C₂-C₄ monocarboxylic acids, such as vinyl acetate and vinyl propionate;
b2′) primary amides of monoethylenically unsaturated C₃-C₆ monocarboxylic acids, more particularly acrylamide or methacrylamide;
b3′) N-vinyl lactams having 7 or 8C atoms, e.g., N-vinylpiperidin-2-one or N-vinylcaprolactam;
b4′) 1-vinylimidazole, 2-methyl-1-vinylimidazole, and 4-methyl-1-vinylimidazole;
b5′) N—C₁-C₄ alkyl amides and N,N-di-C₁-C₄ alkyl amides of monoethylenically unsaturated C₃-C₆ monocarboxylic acids, such as N-methylacrylamide, N-ethylacrylamide, N,N-dimethylacrylamide, N-methylacrylamide, N-ethylacrylamide, N,N-dimethylacrylamide, and tert-butylacrylamide;
b6′) N-vinyl amides of saturated C₁-C₃ monocarboxylic acids, such as N-vinylformamide, N-vinylacetamide, or N-vinylpropionamide;
b7′) C₁-C₃ alkyl acrylates, such as methyl acrylate, ethyl acrylate, n-propyl acrylate, and also methyl methacrylate.

The monomers B may further comprise, in a small amount, monoethylenically unsaturated monomers having a water-solubility of less than 10 g/l. The fraction of these monomers will, however, generally not exceed 10 wt %, based on the total amount of the monomers constituting the polymer P2. Examples of suitable monomers having low water-solubility are, in particular, vinyl esters of branched aliphatic monocarboxylic acids having 6 to 12C atoms.

Examples of suitable cationic monomers are
c1) diallylammonium salts, more particularly diallylammonium chloride,
c2) 3-(C₁-C₄ alkyl)-1-vinylimidazolinium salts, more particularly 3-methyl-1-vinylimidazolinium salts, examples being the chlorides, methosulfates, and sulfates;
c3) tri(C₁-C₄-alkyl)ammonio-C₂-C₄ alkyl esters of acrylic acid and of methacrylic acid, especially the chlorides, methosulfates, and sulfates;
c4) tri-(C₁-C₄-alkyl)ammonio-C₂-C₄ alkyl amides of acrylic acid and of methacrylic acid, especially the chlorides, methosulfates, and sulfates.

Preferred monomers C are the monomers of group c2).

Examples of suitable copolymers of N-vinylpyrrolidone are, in particular, the following co-, ter- and quater-polymers;
P2a copolymers of N-vinylpyrrolidone with N-vinyl acetate, more particularly those composed of 40 to 80 wt % of N-vinylpyrrolidone and 20 to 60 wt % of N-vinyl acetate,
P2b copolymers of N-vinylpyrrolidone with methacrylamide, more particularly those composed of 40 to 80 wt % of N-vinylpyrrolidone and 20 to 60 wt % of methacrylamide,
P2c terpolymers of N-vinylpyrrolidone with methacrylamide and N-vinylcaprolactam, more particularly those composed of 40 to 79 wt % of N-vinylpyrrolidone and 20 to 50 wt % of methacrylamide and 1 to 40 wt % of N-vinylcaprolactam;
P2d terpolymers of N-vinylpyrrolidone with N-vinyl acetate and VeoVa®9, more particularly those composed of 40 to 79 wt % of N-vinylpyrrolidone and 10 to 50 wt % of N-vinyl acetate and 1 to 10 wt % of VeoVa®9;
P2e terpolymers of N-vinylpyrrolidone with methacrylamide and N-vinylimidazole, more particularly those composed of 40 to 79.5 wt % of N-vinylpyrrolidone and 20 to 50 wt % of methacrylamide and 0.5 to 15 wt % of N-vinylimidazole,
P2f terpolymers of N-vinylpyrrolidone with N-vinylcaprolactam and N-vinylimidazole, more particularly those composed of 35 to 89.5 wt % of N-vinylpyrrolidone and 10 to 60 wt % of N-vinylcaprolactam and 0.5 to 15 wt % of N-vinylimidazole,
P2g terpolymers of N-vinylpyrrolidone with methacrylamide and quaternized N-vinylimidazole, e.g., N-vinyl-3-methylimidazolium chloride or N-vinyl-3-methylimidazolium methosulfate, more particularly those composed of 40 to 89 wt % of N-vinylpyrrolidone, 10 to 40 wt % of methacrylamide and 0.5 to 15 wt % of quaternized N-vinylimidazole,
P2h terpolymers of N-vinylpyrrolidone with N-vinylcaprolactam and quaternized N-vinyl-imidazole, e.g., N-vinyl-3-methylimidazolium chloride or N-vinyl-3-methylimidazolium methosulfate, more particularly those composed of 35 to 89 wt % of N-vinylpyrrolidone, 10 to 60 wt % of N-vinylcaprolactam and 0.5 to 15 wt % of quaternized N-vinylimidazole,
P2i quaterpolymers of N-vinylpyrrolidone with methacrylamide, N-vinylimidazole and quaternized N-vinylimidazole, e.g., N-vinyl-3-methylimidazolium chloride or N-vinyl-3-methylimidazolium methosulfate, more particularly those composed of 50 to 89 wt % of N-vinylpyrrolidone, 10 to 40 wt % of methacrylamide, 0.5 to 10 wt % of N-vinylimidazole and 0.5 to 10 wt % of quaternized N-vinylimidazole,
P2k quaterpolymers of N-vinylpyrrolidone with N-vinylcaprolactam, N-vinylimidazole and quaternized N-vinylimidazole, e.g., N-vinyl-3-methylimidazolium chloride or N-vinyl-3-methylimidazolium methosulfate, more particularly those composed of 40 to 89 wt % of N-vinylpyrrolidone, 10 to 55 wt % of N-vinylcaprolactam, 0.5 to 10 wt % of N-vinylimidazole and 0.5 to 10 wt % of quaternized N-vinylimidazole,
and mixtures thereof.

Particularly preferred are the following polymer types, these being homopolymers of N-vinyl-pyrrolidone, and also the copolymer types P2a, P2h, and P2i.

The polymers P2 of the invention are used typically in an amount of 0.5 to 10 wt %, more particularly in an amount of 1 to 5 wt %, based on the polymer P1.

The aqueous coating compositions of the invention further comprise a binder polymer which is customary for these applications and which is also referred to here and below as polymer P1.

The polymers P1 are insoluble in water and are present in the form of disperse polymer particles within the aqueous coating compositions.

The average diameter of the polymers P1 (polymer particles) present in aqueous dispersion is generally in the range from 10 to 1000 nm, frequently in the range from 20 to 500 nm, or more particularly in the range from 40 to 300 nm or in the range from 50 to 200 nm. By average particle diameter this specification means the weight-average D_{w50} figure determined by the analytical ultracentrifuge method (in this regard, cf. S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight Cell AUC Multiplexer: High Resolution Particle Size Distribution and Density Gradient Techniques, W. Mächtle, pages 147 to 175).

Generally speaking, polymers used in the coating compositions of the invention are those whose glass transition temperature is ≧−50 and ≦100° C., more particularly ≧−30 and ≦60° C., and advantageously ≧0 and ≦50° C. The glass transition temperature is determined according to the DSC method (Differential Scanning calorimetry, 20 K/min, midpoint measurement) according to DIN 53765:1994-03 or ISO 11357-2, with sample preparation taking place preferably according to DIN EN ISO 16805:2005.

According to Fox (T. G. Fox, Bull. Am. Phys. Soc. 1956 [Ser. II] 1, page 123 and in accordance with Ullmann's Encyclopädie der technischen Chemie, vol. 19, page 18, 4th edition, Verlag Chemie, Weinheim, 1980) the glass transition temperature of copolymers with no more than low levels of crosslinking is given in good approximation by:

1/Tg=x₁/Tg₁+x₂/Tg₂+ . . . xₙ/Tgₙ,

where x₁, x₂, . . . xₙ are the mass fractions of the monomers 1, 2, . . . n and Tg₁, Tg₂, . . . Tgₙ are the glass transition temperatures of the polymers composed in each case only of one of the monomers 1, 2, . . . n, in degrees Kelvin. The Tg values for the homopolymers of the majority of monomers are known and are listed in, for example, Ullmann's Encyclopedia of Industrial Chemistry, 5^{th} edn., vol. A21, page 169, Verlag Chemie, Weinheim, 1992; further sources of homopolymer glass transition temperatures include, for example, J. Brandrup, E. H. Immergut, Polymer Handbook, 1st edn., J. Wiley, New York, 1966; 2nd edn., J. Wiley, New York, 1975, and 3rd edn., J. Wiley, New York, 1989.

The aqueous dispersion of the polymer P1 is generally an emulsion polymer. Emulsion polymers are familiar to the skilled person and are prepared, for example, in the form of an aqueous polymer dispersion by means of radically initiated aqueous emulsion polymerization of ethylenically unsaturated monomers. This technique has been much described before now, and is therefore well known to the skilled person [cf., e.g., Encyclopedia of Polymer Science and Engineering, vol. 8, pages 659 to 677, John Wiley & Sons, Inc., 1987; D. C. Blackley, Emulsion Polymerisation, pages 155 to 465, Applied Science Publishers, Ltd., Essex, 1975; D. C. Blackley, Polymer Latices, 2nd edition, vol. 1, pages 33 to 415, Chapman & Hall, 1997; H. Warson, The Applications of Synthetic Resin Emulsions, pages 49 to 244, Ernest Benn, Ltd., London, 1972; J. Piirma, Emulsion Polymerisation, pages 1 to 287, Academic Press, 1982; F. Hölscher, Dispersionen synthetischer Hochpolymerer, pages 1 to 160, Springer-Verlag, Berlin, 1969, and patent specification DE-A 40 03 422]. The radically initiated aqueous emulsion polymerization is normally accomplished by dispersing the ethylenically unsaturated monomers in aqueous medium, generally with accompanying use of dispersing assistants, such as emulsifiers and/or protective colloids, and polymerizing them by means of at least one water-soluble radical polymerization initiator. In the aqueous polymer dispersions obtained, the residual amounts of unreacted ethylenically unsaturated monomers are frequently lowered by chemical and/or physical techniques that are likewise known to the skilled person [see, for example, EP-A 771328, DE-A 19624299, DE-A 19621027, DE-A 19741184, DE-A 19741187, DE-A 19805122, DE-A 19828183, DE-A 19839199, DE-A 19840586, and 19847115]; the polymer solids content is adjusted to a desired level by dilution or concentration; or the aqueous polymer dispersion is admixed with further customary adjuvants, such as bactericidal, foam-modifying or viscosity-modifying additives, for example.

As well as these so-called primary aqueous polymer dispersions, the skilled person also knows of what are called secondary aqueous polymer dispersions. These are understood to be aqueous polymer dispersions in whose preparation the polymer is generated outside of the aqueous dispersing medium, as for example in solution in a suitable nonaqueous solvent. This solution is subsequently transferred into the aqueous dispersing medium, and the solvent is separated off with dispersing, generally by distillation.

Advantageously in accordance with the invention it is possible in particular to use those polymers P1 in aqueous dispersion that are composed of:
i) 90 to 99.9 wt %, more particularly 95 to 99.5 wt %, of at least one monomer M1 having a water-solubility of not more than 40 g/l at 20° C. and 1 bar;
ii) 0.1 to 10 wt %, more particularly 0.5 to 5 wt %, of at least one monomer M2 having a water-solubility of at least 50 g/l at 20° C. and 1 bar.

Examples of monomers M1 are
esters of acrylic and/or methacrylic acid with alkanols having 1 to 12C atoms, such as methyl acrylate, methyl methacrylate, ethyl acrylate, n-butyl acrylate, n-butyl methacrylate, n-hexyl acrylate, octyl acrylate, 2-ethylhexyl acrylate, and 2-propylheptyl acrylate;
vinylaromatic hydrocarbons such as styrene;
butadiene;
olefins and haloolefins such as ethylene, propene, vinyl chloride, and vinylidene chloride;
vinyl esters of saturated C₂-C₁₂ monocarboxylic acids such as vinyl acetate, vinyl propionate, vinyl hexanoate, vinyl octanoate, and vinyl esters of Versatic acids,
and mixtures thereof.

Preferred monomers M1 are
esters of acrylic and/or methacrylic acid with alkanols having 1 to 12C atoms, such as methyl acrylate, methyl methacrylate, ethyl acrylate, n-butyl acrylate, n-butyl methacrylate, n-hexyl acrylate, octyl acrylate, 2-ethylhexyl acrylate, and 2-propylheptyl acrylate;
vinylaromatic hydrocarbons such as styrene;
and mixtures thereof.

Particularly preferred monomers M1 are
esters of acrylic and/or methacrylic acid with alkanols having 1 to 12C atoms, such as methyl acrylate, methyl methacrylate, ethyl acrylate, n-butyl acrylate, n-butyl methacrylate, n-hexyl acrylate, octyl acrylate, 2-ethylhexyl acrylate, and 2-propylheptyl acrylate,
and mixtures thereof.

Examples of monomers M2 are
monoethylenically unsaturated monocarboxylic acids having 3 to 8C atoms such as acrylic acid and methacrylic acid;
primary amides of monoethylenically unsaturated monocarboxylic acids having 3 to 8C atoms such as acrylamide and methacrylamide;
monoethylenically unsaturated monomers which carry urea groups or keto groups, such as 2-(2-oxoimidazolidin-1-yl)ethyl (meth)acrylate, 2-ureido(meth)acrylate, N-[2-(2-oxo-oxazolidin-3-yl)ethyl] methacrylate, acetoacetoxyethyl acrylate, acetoacetoxypropyl methacrylate, acetoacetoxybutyl methacrylate, 2-(acetoacetoxy)ethyl methacrylate, diacetoneacrylamide (DAAM) and diacetonemethacrylamide;
ethylenically unsaturated sulfonic acids and their salts such as vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acids, and 2-acrylamido-2-methylpropanesulfonic acid, especially their salts, more particularly their sodium salts;
hydroxyalkyl (meth)acrylates, more particularly 2-hydroxyethyl (meth)acrylate, 3-hydroxypropyl (meth)acrylate, 4-hydroxybutyl (meth)acrylate, etc.

In accordance with the invention it is possible with advantage to use, in particular, those polymers P1, present in aqueous dispersion, that comprise in copolymerized form:
90 to 99.9 wt % of one or more monomers M1a, selected from esters of acrylic and/or methacrylic acid with alkanols having 1 to 12C atoms and styrene and mixtures thereof, or
90 to 99.9 wt % of one or more monomers M1b, selected from mixtures of styrene with butadiene and optionally with esters of acrylic and/or methacrylic acid with alkanols having 1 to 12C atoms, or
90 to 99.9 wt % of one or more monomers M1c, selected from vinyl chloride and/or vinylidene chloride and optionally with esters of acrylic and/or methacrylic acid with alkanols having 1 to 12C atoms and mixtures thereof, or
90 to 99.9 wt % of one or more monomers M1d, selected from vinyl acetate, vinyl propionate, vinyl esters of Versatic acid, vinyl esters of long-chain fatty acids, mixtures thereof with ethylene and/or with esters of acrylic and/or methacrylic acid with alkanols having 1 to 12C atoms;
and
0.1 to 10 wt % of one or more monomers M2, selected in particular from monoethylenically unsaturated monocarboxylic acids having 3 to 8C atoms such as acrylic acid and methacrylic acid and their amides such as acrylamide or methacrylamide.

Particularly preferred polymers P1 are those composed of:
90 to 99.9 wt % of one or more monomers M1a, selected from esters of acrylic and/or methacrylic acid with alkanols having 1 to 12C atoms and styrene and mixtures thereof, more particularly from esters of acrylic and/or methacrylic acid with alkanols having 1 to 12C atoms and mixtures thereof, and
0.1 to 10 wt % of one or more monomers M2, selected in particular from monoethylenically unsaturated monocarboxylic acids having 3 to 8C atoms such as acrylic acid and methacrylic acid and their amides such as acrylamide or methacrylamide.

The aqueous polymer dispersion of the polymers P1 is prepared preferably by radical aqueous emulsion polymerization. In the emulsion polymerization, ethylenically unsaturated compounds (monomers) are polymerized in water, usually using surface-active substances such as ionic and/or nonionic emulsifiers and/or protective colloids or stabilizers to stabilize the monomer droplets and the polymer particles formed subsequently from the monomers. Preferred is the use in total of 0.1 to 2.5 wt % or 0.2 to 2.0 wt %, more particularly 0.3 to 1.5 wt %, of surface-active substances, based on the solids content of the polymer dispersion.

A comprehensive description of suitable protective colloids is found in Houben-Weyl, Methoden der organischen Chemie, volume XIV/1, Makromolekulare Stoffe [Macromolecular compounds], Georg Thieme Verlag, Stuttgart, 1961, pp. 411 to 420. Suitable emulsifiers are also found in Houben-Weyl, Methoden der organischen Chemie, volume 14/1, Makromolekulare Stoffe [Macromolecular compounds], Georg Thieme Verlag, Stuttgart, 1961, pages 192 to 208.

Surface-active substances used preferably are emulsifiers, whose relative molecular weights are usually below those of protective colloids. Suitable emulsifiers are anionic and nonionic emulsifiers and mixtures thereof. It has proven useful in particular to use exclusively anionic emulsifiers, or a combination of at least one anionic emulsifier and at least one nonionic emulsifier.

Useful nonionic emulsifiers are araliphatic or aliphatic nonionic emulsifiers, examples being ethoxylated mono-, di-, and trialkylphenols (EO degree: 3 to 50, alkyl radical: C₄-C₁₀), ethoxylates of long-chain alcohols (EO degree: 3 to 100, alkyl radical: C₈-C₃₆), and also polyethylene oxide/polypropylene oxide homopolymers and copolymers. These polymers may comprise the alkylene oxide units in copolymerized form, distributed randomly or in the form of blocks. EO/PO block copolymers are highly suitable examples. Preference is given to using ethoxylates of long-chain alkanols (alkyl radical C₁-C₃₀, average degree of ethoxylation 5 to 100) and, of these, particular preference to those having a linear C₁₂-C₂₀ alkyl radical and an average degree of ethoxylation of 10 to 50, and also ethoxylated monoalkylphenols.

Suitable anionic emulsifiers are, for example, alkali metal salts and ammonium salts of alkyl sulfates (alkyl radical: C₈-C₂₂), of sulfuric monoesters with ethoxylated alkanols (EO degree: 2 to 50, alkyl radical: C₁₂-C₁₈) and with ethoxylated alkylphenols (EO degree: 3 to 50, alkyl radical: C₄-C₉), of alkylsulfonic acids (alkyl radical: C₁₂-C₁₈), and of alkylarylsulfonic acids (alkyl radical: C₉-C₁₈). Other suitable emulsifiers are found in Houben-Weyl, Methoden der organischen Chemie, volume XIV/1, Makromolekulare Stoffe [Macromolecular compounds], Georg-Thieme-Verlag, Stuttgart, 1961, pp. 192-208). Likewise suitable as anionic emulsifiers are bis(phenylsulfonic acid) ethers and/or their alkali metal salts or ammonium salts which carry a C₄-C₂₄ alkyl group on one or both aromatic rings. These compounds are general knowledge, from U.S. Pat. No. 4,269,749, for example, and are available commercially, as Dowfax® 2A1 (Dow Chemical Company), for example.

The polymer dispersions may further be admixed with customary auxiliaries and adjuvants. These include, for example, pH modifiers, reducing agents, and bleaching agents, such as the alkali metal salts of hydroxymethanesulfinic acid (e.g., Rongalit® C from BASF SE), complexing agents, deodorants, odorants, and viscosity modifiers, such as alcohols, examples being glycerol, methanol, ethanol, tert-butanol, glycol, etc. These auxiliaries and adjuvants may be added to the polymer dispersions in the initial charge, in one of the feeds, or after the end of the polymerization.

The emulsion polymerization can be kicked off using water-soluble initiators. Examples of water-soluble initiators are ammonium salts and alkali metal salts of peroxodisulfuric acid, as for example sodium peroxodisulfate, hydrogen peroxide or organic peroxides, as for example tert-butyl hydroperoxide. Also possessing initiator suitability are systems known as reduction-oxidation (redox) initiator systems. The redox initiator systems consist of at least one, usually inorganic, reducing agent and one organic or inorganic oxidizing agent. The oxidizing component comprises, for example, the emulsion polymerization initiators already identified above. The reducing component comprises, for example, alkali metal salts of sulfurous acid, such as sodium sulfite, sodium hydrogensulfite, alkali metal salts of disulfuryl acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems may be used in conjunction with soluble metal compounds whose metallic component is able to occur in a plurality of valence states. Examples of customary redox initiator systems are ascorbic acid/iron(II) sulfate/sodium peroxydisulfate, tert-butyl hydroperoxide/sodium disulfite, tert-butyl hydroperoxide/Na hydroxymethanesulfinic acid. The individual components, the reducing component for example, may also be mixtures, an example being a mixture of the sodium salt of hydroxymethanesulfinic acid and sodium disulfite.

The stated initiators are used mostly in the form of aqueous solutions, with the lower concentration being determined by the amount of water that is acceptable in the dispersion, and the upper concentration by the solubility of the respective compound in water. In general the concentration of the initiators is 0.1 to 30 wt %, preferably 0.2 to 20 wt %, more preferably 0.3 to 10 wt %, based on the monomers to be polymerized. It is also possible for two or more different initiators to be used in the emulsion polymerization.

The emulsion polymerization may be carried out in one or more stages, with the monomer compositions polymerized in the individual stages generally differing from one another. The monomer compositions differ in particular in respect of the theoretically resulting glass transition temperature and/or in the proportions of the monomers M2.

The emulsion polymerization takes place in general at 30 to 130° C., preferably at 50 to 90° C. The polymerization medium may consist either of water alone or else of mixtures of water and water-miscible liquids such as methanol. Preference is given to using just water. The emulsion polymerization of the first stage may be carried out as a batch operation or in the form of a feed process, including staged or gradient regimes.

The manner in which the initiator is added to the polymerization vessel in the course of the radical aqueous emulsion polymerization is known to a person of ordinary skill in the art. It can be alternatively introduced in its entirety in the initial charge to the polymerization vessel, or else introduced continuously or in stages, at the rate at which it is consumed, in the course of the radical aqueous emulsion polymerization. Specifically, this depends on the chemical nature of the initiator system and also on the polymerization temperature. With preference, a portion is included in the initial charge, and the remainder is supplied to the polymerization zone in line with consumption. In order to remove the residual monomers, it is usual to add initiator after the end of the emulsion polymerization proper as well, in other words after a monomer conversion of at least 95%. With the feed process, the individual components can be added to the reactor from above, in the side, or from below, through the reactor base.

Frequently it is advantageous if the aqueous polymer dispersion obtained after the end of the emulsion polymerization is subjected to an aftertreatment for the purpose of reducing the residual monomer content. This aftertreatment then is either chemical, through completion of the polymerization reaction by using a more effective radical initiator system (referred to as postpolymerization), for example, and/or physical, by stripping of the aqueous polymer dispersion with steam or inert gas, for example. Corresponding chemical and/or physical methods are familiar to the skilled person [see, for example, EP-A 771 328, DE-A 196 24 299, DE-A 196 21 027, DE-A 197 41 184, DE-A 197 41 187, DE-A 198 05 122, DE-A 198 28 183, DE-A 198 39 199, DE-A 198 40 586, and 198 47 115]. The combination of chemical and physical aftertreatment offers the advantage that not only the unreacted ethylenically unsaturated monomers but also other disruptive volatile organic constituents (known as VOCs [volatile organic compounds]) are removed from the aqueous polymer dispersion.

The coating compositions of the invention comprise at least one pigment, more particularly at least one white pigment. In addition, the coating compositions of the invention may comprise one or more fillers, more particularly one or more inorganic fillers.

The fraction of the pigments and fillers in coating compositions may be described in a manner known per se through the pigment volume concentration (PVC). The PVC describes the ratio of the volume of pigments (V_{P}) and fillers (V_{F}) to the total volume, consisting of the volumes of binder (V_{B}), pigments, and fillers in a dried coating film, in percent:

PVC=(V_{P}+V_{F})×100/(V_{P}+V_{F}+V_{B}).

The effects of the additives, in accordance with the invention, are manifested in particular in pigment-containing coating compositions which have a PVC of at least 5, more particularly at least 10. The PVC will preferably not exceed a figure of 50, more particularly 40, and is situated especially in the range from 15 to 35.

Suitable pigments are, for example, inorganic white pigments, such as titanium dioxide, preferably in the rutile form, barium sulfate, zinc oxide, zinc sulfide, basic lead carbonate, antimony trioxide, lithopone (zinc sulfide+barium sulfate), or colored pigments, examples being iron oxides, carbon black, graphite, zinc yellow, zinc green, ultramarine, manganese black, antimony black, manganese violet, Paris blue or Schweinfurt green. Besides the inorganic pigments, the emulsion paints of the invention may also comprise organic colored pigments, examples being sepia, gamboge, Cassel brown, toluidine red, para red, Hansa yellow, indigo, azo dyes, anthraquinoid and indigoid dyes, and also dioxazine, quinacridone, phthalocyanine, isoindolinone and metal-complex pigments. Also suitable are synthetic white pigments with air inclusions for increasing light scattering, such as the Ropaque® and AQACelI® dispersions. Additionally suitable are the Luconyl® brands from BASF SE, such as Luconyl® yellow, Luconyl® brown, and Luconyl® red, for example, especially the transparent variants.

Examples of suitable fillers are alumosilicates, such as feldspars, silicates, such as kaolin, talc, mica, magnesite, alkaline earth metal carbonates, such as calcium carbonate, in the form of calcite or chalk, for example, magnesium carbonate, dolomite, alkaline earth metal sulfates, such as calcium sulfate, silicon dioxide, etc. Finely divided fillers are naturally preferred in the coating material compositions of the invention. The fillers may be used as individual components. In practice, however, filler mixtures have proven particularly appropriate, examples being calcium carbonate/kaolin and calcium carbonate/talc. Glossy paints generally have only small amounts of very finely divided fillers, or do not contain any fillers. Fillers also include matting agents, which accordingly and desirably detract greatly from the gloss. Matting agents are generally transparent and may be organic and inorganic. Examples of matting agents are inorganic silicates, examples being the Syloid® brands from W. R. Grace & Company and the Acematt® brands from Evonik GmbH. Organic matting agents are available, for example, from BYK-Chemie GmbH under the Ceraflour® and Ceramat® brands, and from Deuteron GmbH under the Deuteron MK® brand.

The coating compositions of the invention are preferably designed as a coating material composition containing white pigment—that is, they comprise at least one white pigment and optionally one or more fillers. As white pigment they include, in particular, titanium dioxide, preferably in the rutile form, optionally in combination with one or more fillers. With particular preference the coating compositions of the invention comprise a white pigment, more particularly titanium dioxide, preferably in the rutile form, in combination with one or more fillers, such as chalk, talc or mixtures thereof, for example.

The aqueous coating compositions of the invention (aqueous paint materials) may comprise the polymer P1, the polymer P2, the pigment, and water, and also further auxiliaries.

The customary auxiliaries include
wetting agents or dispersants,
film-forming assistants,
thickeners,
flow control agents,
biocides, and
defoamers.

Wetting agents or dispersants are, for example, sodium, potassium or ammonium poly-phosphates, alkali metal salts and ammonium salts of acrylic or maleic anhydride copolymers, polyphosphonates, such as sodium 1-hydroxyethane-1,1-diphosphonate, and also salts of naphthalenesulfonic acids, more particularly their sodium salts.

Suitable film-forming assistants are, for example, Texanol® from Eastman Chemicals and the glycol ethers and glycol esters available, for example, commercially from BASF SE under the names Solvenon® and Lusolvan®, and from Dow under the trade name Dowanol®. The amount is preferably <10 wt % and more preferably <5 wt % of the total formulation. It is also possible to formulate entirely without solvents.

Suitable thickeners are, for example, associative thickeners, such as polyurethane thickeners. The amount of the thickener is preferably less than 2.5 wt %, more preferably less than 1.5 wt % of thickener, based on the solids content of the paint material.

Further formulating information for wood coatings is described comprehensively in “water-based acrylates for decorative coatings” by the authors M. Schwartz and R. Baumstark, ISBN 3-87870-726-6.

The coating material compositions of the invention are produced in a conventional way by blending of the components in mixing apparatus customary for such purposes. It has been found appropriate to prepare an aqueous paste or dispersion from the pigments, water, and optionally the auxiliaries, and only then to mix the polymeric binder, in other words, generally, the aqueous dispersion of the polymer, with the pigment paste or pigment dispersion.

The paint material of the invention may be applied to substrates in a customary way, such as by brushing, spraying, dipping, rolling, or knifecoating, for example.

The aqueous coating formulations of the invention are suitable with advantage for the coating of substrates, more particularly tannin-containing substrates, such as wood in particular.

The coating of the substrates in this case is accomplished by first coating the substrate with an aqueous coating formulation of the invention and subsequently subjecting the aqueous coating to a drying step, more particularly in the temperature range ≧−10 and ≦50° C., advantageously ≧5 and ≦40° C., and with particular advantage ≧10 and ≦35° C.

It is an advantage that the aqueous coating formulations of the invention which comprise the polymers P2 or mixtures thereof can be used for pretreating tannin-containing substrates. Pretreatment in this case takes place before the actual painting. Furthermore, the aqueous coating compositions may also be paint formulations which as well as the polymers P2 or mixtures thereof also comprise the customary components familiar in their type and amount to the skilled person, such as, for example, binders (especially in the form of aqueous polymer dispersions), thickeners, pigment dispersants, other dispersants, emulsifiers, biocides, defoamers, film-forming assistants, organic solvents, pigments, or fillers, etc.

The applied amount of coating composition is preferably selected such that the amount of polymer P2 or mixtures thereof is ≧0.001 and ≦100 g/m² of substrate. If the aqueous coating formulation is being used for pretreatment, the amount of polymer P2 or mixtures thereof that is applied to the substrate is preferably ≧0.01 and ≦50 g/m² and more particularly ≧0.02 and ≦20 g/m². If, on the other hand, the aqueous coating formulation is being used in the form of a paint formulation, the amount of polymer P2 or mixtures thereof applied to the substrate is preferably ≧0.005 and ≦20 g/m² and more particularly ≧0.01 and ≦10 g/m².

The tannin-containing substrates coated with a coating formulation of the invention have excellent resistance toward color runs and color strikethrough not only during application and drying (“early tannin blocking effect”) but also after drying, on exposure to water or to weathering conditions (“late tannin blocking effect”).

Nonlimiting examples below are intended to elucidate the invention.

### EXAMPLES

1. Analysis

The solids content was determined by drying a defined amount of the aqueous polymer dispersion (approximately 2 g) to constant weight in a drying cabinet (approximately 2 hours) in an aluminum crucible having an internal diameter of approximately 5 cm, at 120° C. Two separate measurements were conducted. The value reported in the example represents the average value of the two results.

The average particle diameter of the polymer particles was determined by dynamic light scattering of an aqueous polymer dispersion diluted with deionized water to 0.005 to 0.01 wt %, at 23° C., by means of a High Performance Particle Sizer (HPPS) from Malvern Instruments, England. The figure reported is the average diameter of the cumulant evaluation (cumulant z_{average}) of the measured autocorrelation function (ISO standard 13321).

The glass transition temperature was determined by the DSC method (differential scanning calorimetry, 20 K/min, midpoint measurement, DIN 53765) by means of a DSC 822 instrument (series TA 8000) from Mettler-Toledo.

2. Ingredients:

2.1. Preparation of an Aqueous Polymer Dispersion (Polymer P1)

A reaction vessel equipped with stirrer, thermometer, reflux condenser, and feed vessels was charged at room temperature under a nitrogen atmosphere with a mixture of 2900 g of deionized water, 24 g of a 15 wt % strength aqueous solution of sodium lauryl sulfate, 150 g of a 20 wt % strength aqueous solution of a C₁₆C₁₈ fatty alcohol polyethoxylate, 37.2 g of a 6 wt % strength aqueous solution of sodium bicarbonate, and 314 g of feed 1.

Feed 1 consisted of 1945 g of deionized water, 140 g of a 15 wt % strength aqueous solution of sodium lauryl sulfate, 113 g of a 32 wt % strength aqueous solution of a C₁₂C₁₄ fatty alcohol polyethoxysulfate sodium salt (Disponil FES 77; commercial product from Cognis), 150 g of a 20 wt % strength aqueous solution of a C₁₆C₁₈ fatty alcohol polyethoxylate, 67 g of acrylic acid, 170 g of a 50 wt % strength aqueous solution of acrylamide, 3060 g of n-butyl acrylate, and 2370 g of methyl methacrylate in homogeneous emulsion.

The initial charge was heated to 90° C. with stirring. Subsequently, with this temperature maintained, 32 g of a 7 wt % strength aqueous solution of sodium peroxodisulfate were added and the resulting mixture was stirred for 5 minutes. Thereafter, beginning simultaneously, the remainder of feed 1 and 185 g of a 7 wt % strength aqueous solution of sodium peroxodisulfate were metered in continuously over the course of 3 hours at constant volume flow rates, via separate feed lines.

After the end of the feeds, postpolymerization took place for 15 minutes, after which the aqueous polymer dispersion obtained was admixed with 40 g of a 25 wt % strength aqueous solution of ammonia. After the aqueous polymer dispersion obtained had been cooled to 85° C., it was admixed with, beginning simultaneously, 76 g of a 10 wt % strength aqueous solution of tert-butyl hydroperoxide and 101 g of a 13.1 wt % strength aqueous solution of acetone bisulfite (1:1 adduct of acetone and sodium bisulfite) over the course of 1 hour, continuously, with constant volume flow rates. After the end of the additions, the aqueous polymer dispersion was further admixed with 80 g of deionized water and 36 g of Acticid® MBS (commercial product from Thor Chemie GmbH). Subsequently the aqueous polymer dispersion was cooled to room temperature and filtered through a 125 μm filter.

The aqueous polymer dispersion obtained had a solids content of 50.2 wt % and a glass transition temperature of 17° C. The average particle diameter was 115 nm.

2.2 Polymers P2

Polymer P2.1: terpolymer of 40 wt % N-vinylpyrrolidone, 50 wt % N-vinylcaprolactam, and 10 wt % N-vinyl-3-methylimidazolium chloride.

Polymer P2.2: quaterpolymer of 55 wt % N-vinylpyrrolidone, 29 wt % methacrylamide, 10 wt % N-vinylimidazole, and 6 wt % N-vinyl-3-methylimidazolium methosulfate.

Polymer P2.3: terpolymer of 65 wt % N-vinylpyrrolidone, 30 wt % methacrylamide, and 5 wt % N-vinylimidazole.

Polymer P2.4: copolymer of 61 wt % N-vinylpyrrolidone, 39 wt % vinyl acetate, having a K value, determined on a 1 wt % strength aqueous solution, of 24.9, prepared as per example 1 of EP 418721.

Polymer P2.5: terpolymer of 60 wt % N-vinylpyrrolidone, 37 wt % vinyl acetate, and 3 wt % VeoVA 9* having a K value, determined on a 1 wt % strength aqueous solution, of 63, prepared as per example 1 of DE 19950229.

*Vinyl ester of a Versatic acid with 9C atoms (CAS 54423-67-5)

Polymer P2.6: commercially customary homopolymer of N-vinylpyrrolidone, with a K value of 30, e.g., Kollidon 30.

3. Preparation of the Modified Aqueous Polymer Dispersions

The compositions of the invention were prepared by adding the respective polymer P2 to a portion of the aqueous polymer dispersion prepared under 2.1, at room temperature, with stirring. The amounts of the polymers P2 here were calculated so as to give the values indicated in table 1 below. The figure reported is the amount of polymer P2 in parts by weight, based on 100 parts by weight of polymer P1 in the aqueous polymer dispersion used (solid/solid). The corresponding designation of the modified aqueous polymer dispersion obtained is likewise reported in table 1.

TABLE 1
Preparation of the aqueous polymer dispersions
modified with the polymers P2

| | Amount [per 100 parts | |
|---|---|---|
| | by weight solid of the | Designation of the modified |
| Polymer P2: | aqueous polymer dispersion] | aqueous polymer dispersion |
| — | 0 | dispersion D0 |
| P2.1 | 3.0 | dispersion D1 |
| P2.2 | 3.0 | dispersion D2 |
| P2.3 | 3.0 | dispersion D3 |
| P2.4 | 3.0 | dispersion D4 |
| P2.5 | 3.0 | dispersion D5 |
| P2.6 | 3.0 | dispersion D6 |

4. Production of a Paint Formulation

In order to produce the corresponding paint formulations, the components listed in tables 2 and 3 below were mixed homogeneously in the stated amount and in the stated order, at room temperature, using a toothed disk stirrer, to form color pastes.

TABLE 2
Components of color paste F1

| Constituent | Parts by weight [g] |
|---|---|
| Deionized water | 102.5 |
| Thickener¹⁾ | 8.2 |
| Pigment dispersant²⁾ | 2.0 |
| Dispersant³⁾ | 4.1 |
| Biocide⁴⁾ | 2.0 |
| Defoamer⁵⁾ | 5.1 |
| Film-forming assistant⁶⁾ | 20.5 |
| Pigment⁷⁾ | 204.9 |
| Filler⁸⁾ | 82.0 |
| Filler⁹⁾ | 30.7 |
| Solvent¹⁰⁾ | 15.4 |
| Thickener¹¹⁾ | 4.6 |

¹⁾Coapur ® XS 73 from Omya GmbH, Germany
²⁾Pigmentverteiler ® MD 20 from BASF SE, Germany
³⁾25 wt % strength aqueous solution of sodium polyphosphate from Sigma Aldrich Chemie GmbH, Germany
⁴⁾Parmetol ® A 26 from Schülke & Mayr GmbH, Germany
⁵⁾Byk ® 024 from Byk-Chemie GmbH, Germany
⁶⁾Lusolvan ® PP from BASF SE, Germany
⁷⁾Titanium dioxide; Kronos ® 2056 from Kronos Titan GmbH, Germany
⁸⁾Calcium carbonate; Omyacarb ® 5 GU from Omya GmbH, Germany
⁹⁾Talc; Finntalc ® M 30 SL from Mondo Minerals, Netherlands
¹⁰⁾Butyl diglycol from BASF SE, Germany
¹¹⁾Collacral ® LR 8990 from BASF SE, Germany

TABLE 3
Components of color paste F2

| Constituent | Parts by weight [g] |
|---|---|
| Deionized water | 119.5 |
| Solvent¹²⁾ | 33.5 |
| Dispersant¹³⁾ | 13.7 |
| Biocide¹⁴⁾ | 1.0 |
| Emulsifier¹⁵⁾ | 1.5 |
| Thickener 1 ¹⁶⁾ | 6.4 |
| Thickener 2 ¹⁷⁾ | 7.0 |
| Defoamer¹⁸⁾ | 3.4 |
| Pigment¹⁹⁾ | 228.8 |
| Filler²⁰⁾ | 81.6 |
| Thickener 3 ²¹⁾ | 38.3 |
| Film-forming assistant²²⁾ | 6.7 |

¹²⁾Propylene Glycol from BASF SE, Germany
¹³⁾Sokalan ® CP9 from BASF SE, Germany
¹⁴⁾Acticide ® MBS from Thor, Germany
¹⁵⁾Lutensol ® XL 80 from BASF SE, Germany
¹⁶⁾ Collacral ® LR 8990 from BASF SE, Germany
¹⁷⁾ Collacral ® LR 8989 from BASF SE, Germany
¹⁸⁾Che Coat DF 6682 from C. H. Erbslöh, Germany
¹⁹⁾Tiona ®595 from Millenium Chemicals (Lyondell Company), Belgium
²⁰⁾Omyacarb ® 5 GU from Omya GmbH, Germany
²¹⁾ Natrosol plus ®, 2% strength from Hercules, Belgium
²²⁾Texanol ® from Krahn-Chemie GmbH, Germany

The color pastes, prepared freshly in accordance with the procedure described above, were filtered through a 125 μm filter, with reduced pressure applied, in order to remove air bubbles and larger pigment agglomerates. After that, the color pastes F1 were admixed homogeneously with 438.5 g of the dispersions and 79.4 g of deionized water, and the color pastes F2 with 393.5 g of the dispersions and 64.9 g of deionized water. The paint formulations obtained accordingly were then stored at rest for one day at room temperature.

5. Performance Investigations

The performance investigations were carried out with untreated merbau, cedar, and oak. For this purpose, boards of the various woods were used, with dimensions of 150×50×5 mm, which had been freed from adhering dust using a dry cotton cloth. In order to minimize deviations and ensure compatibility, the test series were conducted on one board in each case. The procedure here was that first of all areas on the respective board of 130×40 mm were coated uniformly with 0.46 g of one each of the formulations, and the coated boards were then dried in a conditioned chamber at 23° C. and 50% relative humidity for two hours (coat 1). After that 0.32 g of the respective formulation was applied uniformly to each of these coatings over an area of 90×40 mm, with drying as for the first coat (coat 2). Thereafter, 0.18 g of the respective formulation was applied uniformly to this second coat over an area of 50×40 mm (coat 3), after which the correspondingly coated boards were stored for 24 hours in a conditioned chamber at 23° C. and 50% relative humidity. Since each of the coating operations was started at one side edge, congruently, the respective paint films had a 40×40 mm area which had been coated only once (coat 1), a 40×40 mm area which had been coated twice (coat 1 plus coat 2), and a 50×40 mm area which had been coated three times (coat 1 plus coat 2 plus coat 3). As a reference, each of the corresponding paint formulations was applied to grease-free glass plates and dried.

Discoloration was measured by two different methods. With method 1, the extent of discoloration resulting from the application of each of the aqueous paint formulations and its drying was ascertained (“early tannin blocking”). Method 2 measured the extent of discoloration resulting from the effect of water on the respective dried paint film (“late tannin blocking”).

Method 1

Using a photospectrometer (Minolta CM-508i spectrometer), at least two points on coat 3 of the respective paint films on the wooden boards and glass plates were used for measuring the so-called L, a and b values, and subsequently the respective average was formed. After that, the differences between the averaged L, a and b values of the respective paint films on the wooden boards and glass plates were ascertained (ΔL, Δa and Δb). One measure of the respective deviation in color is the ΔE value, which was determined as follows:

ΔE=\sqrt{(ΔL)²+(Δa)²+(Δb)²}

The smaller the ΔE value, the smaller the deviation in color (and hence the less the “bleeding” of the wood in question). This means that the lower the ΔE value of each of the paint films, the less colored substances have been leached from the wood in question in the course of the application and drying of the respective paint formulation. The results obtained from the various measurement series are listed in table 4.

Note: the so-called CIE-Lab color space is formed from the lightness axis L, the red/green axis a, and the yellow/blue axis b. Corresponding color deviations are indicated by the ΔE value (as defined above).

Method 2

In each case, one drop of deionized water was applied to coat 3 of each of the paint films on the wooden boards, and the paint films thus treated were dried in a conditioned chamber for 12 hours at 23° C. and 50% relative humidity. After that, the locations with the dried water drops were evaluated in accordance with the following scale of ratings:

Rating Evaluation
0 the full ring of water is clearly apparent and dark brown in color
1 the full ring of water is clearly apparent and light brown in color
2 the outer ring of water can be seen
3 parts of the outer ring of water can be seen
4 the ring of water is still perceptible, but not colored
5 it is impossible to tell where the drop of water was

At least two measurements were carried out on each paint film. The values reported in table 3 represent the averages of these assessments.

TABLE 4
Results of the performance investigations

| Measurement | Modified polymer | Color | | |
|---|---|---|---|---|
| series | dispersion | paste | ΔE¹⁾ | Rating²⁾ |
| 1 (merbau) | D0 | F1 | 1.318 | 2 |
| | D1 | F1 | 0.788 | 2 |
| | D2 | F1 | 0.783 | 2 |
| | D3 | F1 | 1.120 | 2 |
| | D4 | F1 | 0.680 | 3 |
| | D5 | F1 | 0.994 | 2 |
| | D6 | F1 | 0.539 | 2 |
| 2 (cedar) | D0 | F1 | 1.058 | 2 |
| | D2 | F1 | 0.861 | 2 |
| | D3 | F1 | 0.579 | 2 |
| | D4 | F1 | 0.659 | 2 |
| | D5 | F1 | 0.573 | 2 |
| | D6 | F1 | 0.441 | 2 |
| 3 (merbau) | D0 | F2 | 1.775 | 2 |
| | D4 | F2 | 0.801 | 3 |
| 4 (cedar) | D0 | F2 | 2.128 | 1 |
| | D4 | F2 | 1.676 | 2 |

The results described above have shown that the addition of polymers P2 in polymer dispersions leads to an improved tannin blocking effect (especially “early tannin blocking”) of the resulting coatings.

1. An aqueous, pigment-containing coating composition, comprising:
a) at least one polymer P1 in the form of an aqueous polymer dispersion; and
b) at least one water-soluble polymer P2 which comprises an ethylenically unsaturated monomer M and which comprises in copolymerized form at least 30 wt %, based on a total amount of the monomers M, of N-vinylpyrrolidone.

2. The aqueous, pigment-containing coating composition according to claim 1, wherein the water-soluble polymer P2 is selected from the group consisting of homopolymers of N-vinylpyrrolidone.

3. The aqueous, pigment-containing coating composition according to claim 1, wherein the water-soluble polymer P2 is selected from the group consisting of copolymers which comprise in copolymerized form
a) 30 to 90 wt % of N-vinylpyrrolidone as monomer A,
b) 10 to 70 wt % of at least one neutral, monoethylenically unsaturated monomer as monomer B, and
c) optionally, 0 to 20 wt % of a cationic monomer as monomer C,
the values in wt % being based on the total mass of the monomers M, and the monomers A and B making up at least 80 wt %, based on the total mass of the monomers M.

4. The aqueous, pigment-containing composition according to claim 3, wherein the monomers B are selected from the group consisting of
b1) vinyl esters of saturated C₂-C₁₂ monocarboxylic acids,
b2) primary amides of monoethylenically unsaturated C₃-C₆ monocarboxylic acids
b3) N-vinyl lactams having 7 to 10C atoms,
b4) vinyl-substituted nitrogen heteroaromatics,
b5) N—C₁-C₄ alkyl amides and N,N-di-C₁-C₄ alkyl amides of monoethylenically unsaturated C₃-C₆ monocarboxylic acids,
b6) N-vinyl amides of saturated C₁-C₆ monocarboxylic acids,
b7) C₁-C₃ alkyl acrylates and methyl methacrylate;
and mixtures thereof.

5. The aqueous, pigment-containing coating composition according to claim 3, the polymer P2 being selected from the group consisting of
copolymers of N-vinylpyrrolidone with N-vinyl acetate,
copolymers of N-vinylpyrrolidone with methacrylamide,
terpolymers of N-vinylpyrrolidone with N-vinyl acetate and vinyl ester of a branched aliphatic monocarboxylic acid having 9C atoms,
terpolymers of N-vinylpyrrolidone with methacrylamide and N-vinylcaprolactam,
terpolymers of N-vinylpyrrolidone with methacrylamide and N-vinylimidazole,
terpolymers of N-vinylpyrrolidone with methacrylamide and quaternized N-vinylimidazole,
terpolymers of N-vinylpyrrolidone with N-vinylcaprolactam and N-vinylimidazole,
quaterpolymers of N-vinylpyrrolidone with methacrylamide, N-vinylimidazole, and quaternized N-vinylimidazole,
quaterpolymers of N-vinylpyrrolidone with N-vinylcaprolactam, N-vinylimidazole and quaternized N-vinylimidazole,
and mixtures thereof.

6. The aqueous, pigment-containing coating composition according to claim 1, comprising the water-soluble polymer P2 in an amount of 0 5 to 10 wt %, based on the polymer P1.

7. The aqueous, pigment-containing coating composition according to claim 1, wherein the water-soluble polymer has a number-average molecular weight Mₙ of 5000 to 200 000 g/mol, determined by means of gel permeation chromatography (GPC), or a K value in the range from 10 to 100.

8. The aqueous, pigment-containing coating composition according to claim 1, wherein the polymer P1 has a glass transition temperature Tg, determined by DSC to ISO 11357-2, in the range from −30 to +60° C.

9. The aqueous, pigment-containing coating composition according to claim 1, wherein the polymer P1 comprises
i) 90 to 99.9 wt % of at least one monomer M1 which has a water-solubility of not more than 40 g/l at 20° C. and 1 bar; and
ii) 0.1 to 10 wt % of at least one monomer M2 which has a water-solubility of at least 50 g/l at 20° C. and 1 bar.

10. The aqueous, pigment-containing composition according to claim 1, in the form of a formulation containing white pigment.

11. A method for coating a substrate containing tannin, said method comprising:
coating said surface with a pigment-containing coating composition according to claim 1.

12. A method for improving a tannin blocking effect of an aqueous coating composition, said method comprising:
adding to said aqueous coating composition a water-soluble polymer which comprises an ethylenically unsaturated monomer M and which comprises in copolymerized form at least 30 wt %, based on the monomer M, of N-vinylpyrrolidone.

13. A method for coating a substrate containing tannin, comprising:
first coating the substrate with a pigment-containing coating composition according to claim 1 and subsequently, subjecting the aqueous coating to a drying step.

14. The method according to claim 13, wherein the amount of coating formulation is selected such that the amount of water-soluble polymer is in the range from 0.001 to 100 g/m² of substrate.

15. A coated substrate containing tannin, obtainable by a method according to claim 13.
